(19) United States
(12) Patent Application Publication
(10) Pub. No.: US 2016/0268939 A1
(43) Pub. Date: Sep. 15, 2016

(54) MOTOR DRIVING DEVICE WITH ROTATION AND STOP SETTING MODE AND THE DRIVING METHOD THEREOF

(71) Applicant: AMteck SEMICONDUCTOR CO., LTD., NEW TAIPEI CITY (TW)

(72) Inventors: TENG-HUI LEE, NEW TAIPEI CITY (TW); KUO-YUNG YU, NEW TAIPEI CITY (TW)

(21) Appl. No.: 14/948,642

(22) Filed: Nov. 23, 2015

(30) Foreign Application Priority Data
Mar. 13, 2015 (TW) 104108047

(51) Int. Cl. H02P 7/29

(52) U.S. Cl. CPC H02P 7/29

(57) ABSTRACT

A motor driving device with stop mode setting and driving method thereof comprises a PWM converting circuit, an oscillator circuit, a first comparator, a second comparator, and a control unit. The second comparator compares a tunable stop setting signal with an analog signal to output a stop setting signal to the control unit. Therefore, the control unit determines a duty cycle for stopping a motor, and thus reducing energy loss of the motor and promoting motor efficiency.

### FIELD OF THE INVENTION

The present invention relates to a motor driving device and a driving method thereof, and more particularly relates to a motor driving device and a driving method with rotation and stop mode setting for decreasing the motor energy loss and increasing work efficiency so as to achieve the purpose of energy conservation and reduce carbon emissions.

### BACKGROUND OF THE INVENTION

The conventional method for driving a motor is by applying pulse width modulation (PWM), but the motor rotation speed curve cannot be modulated due to the linear relationship between the output of the motor rotation speed and the input of the motor duty cycle. In order to solve the problems aforementioned, as illustrated in U.S. Pat. No. 8,847,537 to Lee et al., Lee et al disclosed a motor driving device for adjusting motor speed and the driving method thereof, and the motor driving device. As shown in FIG. 1, the motor driving device includes a PWM converting circuit 10, an oscillation circuit 11, a comparator 12, and a control unit 13. In the motor driving device, a control signal 101, an adjustable highest setting voltage signal (VH) 102, and an adjustable lowest setting voltage signal (VL) 103 are converted into an analog signal (VTH) by the PWM converting circuit 10, and the comparator 12 compares the analog signal with a triangular signal (TRI) generated from oscillation circuit 11 to output a driving signal to the control unit 13 for controlling the rotation speed of the motor 14.

In recent years, the global warming problem is getting worse, and thus the various industries provides several methods for conserving energy and reducing carbon emissions to mitigate the global warming Accordingly, the present invention provides a motor driving device and a driving method with a settable rotation and stop mode. By using the adjustable stop setting voltage signal, the motor stop duty cycle is to be set when the motor action is not required or the motor is into stand-by mode, such that the motor consumption can be decreased, the motor work efficiency can be improved, and the specification of energy conservation and reduction of carbon emissions can also be achieved.

### SUMMARY OF THE INVENTION

In order to solve the aforementioned drawbacks, the major objective of the present invention is to provide a motor driving device with a rotation and stop setting mode and the motor driving device utilizes a second comparator for comparing an adjustable stop setting signal with an analog signal to output a stop setting signal to a control unit. The control unit receives a driving signal from the first comparator and the stop setting signal from the second comparator to determine a motor stop duty cycle, such that the motor consumption can be decreased, the motor work efficiency can be increased, and the energy conservation and reduction of carbon emissions can also be met.

According to the above objective, a motor driving device with a rotation and stop setting mode of the present invention includes a PWM converting circuit, an oscillation circuit, a first comparator, a second comparator, and a control unit. The PWM converting circuit receives an adjustable highest setting voltage signal (VH), an adjustable lowest voltage signal (VL), and a control signal and outputs an analog signal to the first comparator. The oscillation circuit generates a triangular signal to the first comparator and the first comparator receives the analog signal and the triangular signal to output a driving signal to the control unit. The second comparator includes a first input terminal, a second input terminal, and an output terminal, in which the first input terminal receives an adjustable stop setting signal, and the second input terminal receives the analog signal, then the second comparator compares the adjustable stop setting signal with the analog signal to output a stop setting signal to the control unit from the output terminal of the second comparator so as to the control unit receives the driving signal and the stop setting signal to determine a motor stop duty cycle.

A motor driving method with a rotation and stop setting mode of the present invention also includes: receiving an adjustable highest setting voltage signal (VH), an adjustable lowest setting voltage signal (VL), and a control signal to generate an analog signal; providing a triangular signal; comparing the analog signal with the triangular signal to generate a driving signal; comparing the analog signal with an adjustable stop setting signal to output a stop setting control signal; and receiving the driving signal and the stop setting control signal to determine a motor stop duty cycle.

According to aforementioned, with a rotation and stop setting mode of a motor driving device, the second comparator compares an adjustable stop setting signal with an analog signal to output a stop setting signal to the control unit. The control unit receives a driving signal outputted from the first comparator and the stop setting signal outputted from the second comparator to determine a motor stop duty cycle such that motor consumption can be decreased, the motor work efficiency can be improved and the energy conservation and reduction of carbon emissions can also be met.

### BRIEF DESCRIPTION OF THE DRAWINGS

The present invention will be apparent to those skilled in the art by reading the following description of a preferred embodiment thereof with reference to the drawings, in which:

FIG. 1 shows a schematic view of the motor driving device with adjustable rotation speed of the motor of the prior art.

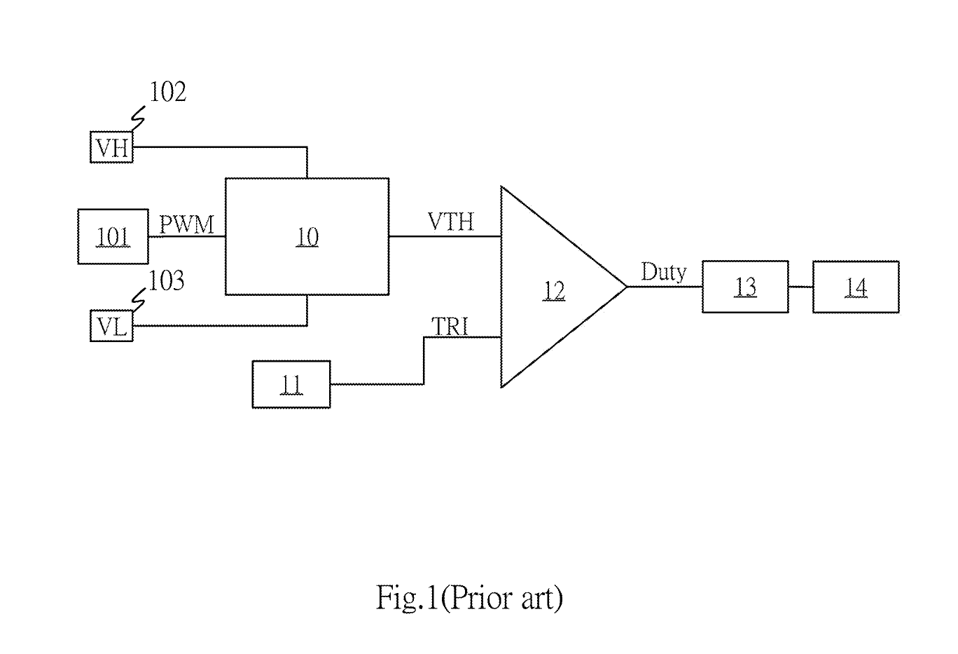

FIG. 2 shows a schematic view of the motor driving device with motor stop setting of the embodiment of the present invention.

FIG. 3A shows a waveform in the first embodiment of the present invention.

FIG. 3B shows a motor rotation speed curve diagram in the first embodiment of the present invention.

FIG. 4A shows a waveform in the second embodiment of the present invention.

FIG. 4B shows a motor rotation speed curve diagram in the second embodiment of the present invention.

FIG. 5A shows a waveform in the third embodiment of the present invention.

FIG. 5B shows a motor speed curve diagram in the third embodiment of the present invention.

FIG. 6 shows a flowchart of illustrating the motor driving method in the present invention.

### DETAILED DESCRIPTION OF THE PREFERRED EMBODIMENT

The basic principle and function of the motor in the present invention is well known by a person skilled in the art. The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

The present invention relates to a motor driving device with a rotation and stop setting mode, more particularly, the present invention provides a motor driving device includes a PWM converting circuit, an oscillation circuit, a first comparator, a second comparator, and control unit.

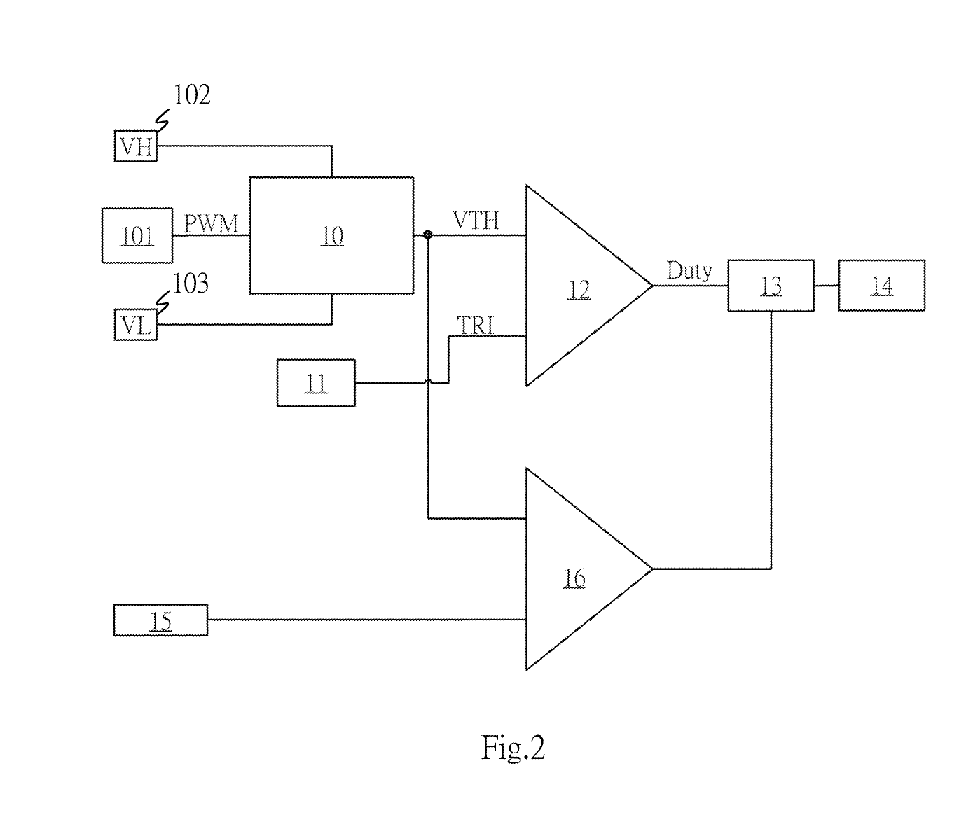

First, please refer to FIG. 2, which shows the schematic view of the motor driving device in accordance with the present invention.

As shown in FIG. 2, the motor driving device includes a PWM converting circuit 10, an oscillation circuit 11, a first comparator 12, a second comparator 16, and a control unit 13. The PWM converting circuit 10 has a first input terminal, a second input terminal, a third input terminal, and an output terminal, in which the first input terminal receives a control signal 101, and the second input terminal receives an adjustable highest setting voltage signal (VH) 102, the third input terminal receives an adjustable lowest setting voltage signal (VL) 103, and then the output terminal of the PWM converting circuit 10 outputs an analog signal (VTH) to the second input terminal of the first comparator 12 and the second input terminal of the second comparator 16. The control signal is a PWM signal, such as a PWM signal provided by a personal computer. The analog signal can be changed by tuning the control signal 101, the adjustable highest setting voltage signal 102, or the adjustable lowest setting voltage signal 103. The oscillation circuit 11 generates a triangular signal and transmits to the first input terminal of the first comparator 12, in which the triangular signal can be adjusted between a high voltage level and a low voltage level. In addition, the first comparator 12 compares the triangular signal (TRI) with the analog signal (VTH) to generate a driving signal and transmit the driving signal to the control unit 13 after the first input terminal of the first comparator 12 received triangular signal (TRI) and the second input terminal of the second comparator 16 received the analog signal (VTH). After the second input terminal of the second comparator 16 received the analog signal and the first input terminal received the adjustable stop setting signal 15, the analog signal (VTH) is compared with the adjustable stop setting signal (Vstop) 15 and a setting stop signal is transmitted and outputted to the control unit 13. After the control unit 13 received the driving signal and the stop setting signal, the motor stop duty cycle of the motor 14 can be determined so as to control the motor 14, in which the motor 14 can be a single phase motor or a three phase motor. The analog signal (VTH) is converted by a conversion equation (1), and the conversion equation (1) is expressed as:

VTH=(VH−VL)×(Duty cycle)+VL (1)

The motor stop duty cycle can be achieved by the following equation (2):

(Stop duty cycle)=(Vstop−VL)/(VH−VL)×100% (2)

Obviously, the motor stop duty cycle can be set by setting different adjustable stop setting signal 15. For example, when the adjustable highest setting voltage signal 102 is 3.75V, the adjustable lowest setting voltage signal 103 is 1.25V, and the adjustable stop setting signal 15 is 2V, the motor stop duty cycle can be calculated as 30% according to above equation. That is, in the case of the duty cycle of the control signal 101 is less than 30%, a stop control signal is outputted to the control unit 13 so as to stop the motor 14 by control unit 13, after the analog signal is compared with adjustable stop setting signal 15 by the second comparator 16.

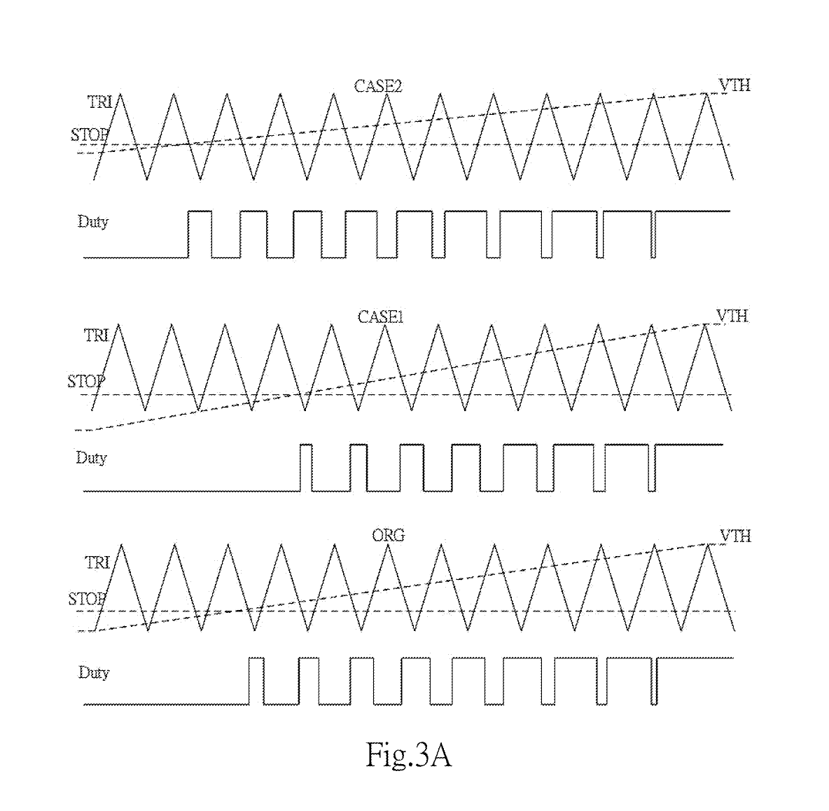

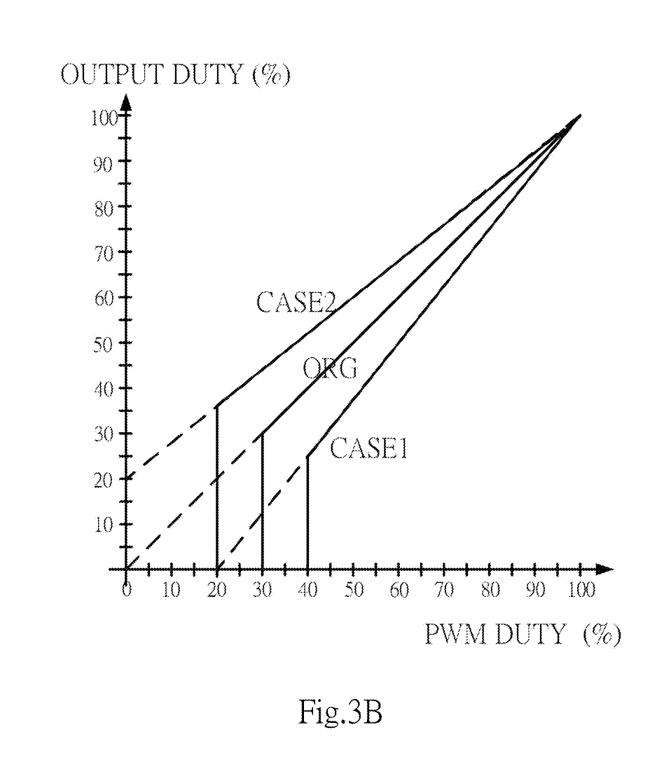

Next, please refer to FIG. 3A, which shows the waveform in the first embodiment of the present invention.

As shown in FIG. 3A, in the first embodiment of the present invention, the high voltage level of the triangular signal is fixed at 3.75V as a constant value and low voltage level of the triangular signal is set at 1.25V, and the adjustable highest setting voltage signal is fixed at 3.75V as a constant valve to adjust the adjustable lowest setting voltage signal (VL). Under the aforementioned conditions, three status can illustrate the result of the comparison: ORG(VH=3.75V, and VL=1.25V), CASE1(VH=3.75V, and VL=0.625V), and CASE2(VH=3.75V, and VL=1.75V) are combined with the adjustable stop setting signal respectively such that the adjustable stop setting signal and the analog signal are inputted into the second comparator 16 to be compared to determine the motor stop duty cycle of the motor 14.

Please still refer to FIG. 3A, when the motor status is at ORG status, the high voltage level of the triangular signal is fixed at 3.75V, the low voltage level of the triangular signal is fixed at 1.25V, the adjustable highest setting voltage signal is set at 3.75V, the adjustable lowest setting voltage signal is set at 1.25V, and the adjustable stop setting signal is set at 2V, and the analog signal will vary between 1.25V and 3.75V and the analog signal is obtained by calculating the equation (1). Furthermore, when the adjustable stop setting is set at 2V, the analog signal is compared with the stop setting signal to generate the ORG waveform as shown in FIG. 3A. When the duty cycle of the motor is less than 30% that is calculated by equation (2), the action of the motor can be determined at stop rotation status. Therefore, when the voltage level of the analog signal is less than that of the adjustable stop setting voltage signal (2V), the stop control signal is outputted to stop the rotation of the motor 14 according to the adjustable setting stop signal. On the other hand, when the analog signal is higher than that of the adjustable stop setting signal (2V), the analog signal is compared with the triangular signal to output the motor speed ratio (Duty %), and the motor speed ratio will change linearly.

Please also refer to FIG. 3A. if the motor status is at CASE1 status, the high voltage level of the triangular signal is fixed at 3.75V, the low voltage level of the triangular signal is fixed at 1.25V, the adjustable highest setting voltage signal is set at 3.75V, the adjustable lowest setting voltage signal is set at 0.625V, and the adjustable stop setting signal is set at 1.875V, and the analog signal will vary between 0.625V and 3.75V and the analog signal is obtained by calculating the equation (1). Since the voltage level of the analog signal begins to change from 0.625V, the analog signal contacts with the triangular signal until the voltage level is changed to 1.25V, so that the motor rotation speed ratio is outputted. Furthermore, when the adjustable stop setting is set at 1.875V, the analog signal is compared with the stop setting signal to generate the waveform of CASE1 as shown in FIG. 3A. When the duty cycle of the motor is less than 40% and the duty cycle is obtained by calculating the equation (2), the motor stops rotating. Therefore, if the voltage level of the analog signal is less than that of the adjustable stop setting voltage signal (1.875V), the stop control signal is outputted to stop the rotation of the motor. On the other hand, if the voltage level of the analog signal is higher than that of the adjustable stop setting signal (1.875V), the analog signal is compared with the triangular signal to output the motor rotation speed ratio and the motor rotation speed ratio will change linearly.

Please continue to refer to FIG. 3A. if the motor status is at CASE2, the high voltage level of the triangular signal is fixed at 3.75V, the low voltage level of the triangular signal is fixed at 1.25V, the adjustable highest setting voltage signal is set at 3.75V, the adjustable lowest setting voltage signal is set at 1.75V, the adjustable stop setting signal is set at 2.15V, and the analog signal will vary between 1.75V and 3.75V and the analog signal is obtained by calculating the equation (1). Since the voltage level of the analog signal of 1.75V is contacted with that of the triangular signal, the motor rotation speed ratio is outputted at the beginning. Furthermore, when the adjustable stop setting is set at 2.15V the analog signal is compared with the stop setting signal to generate the waveform of CASE2 as shown in FIG. 3A. When the duty cycle of the motor is less than 20% and the duty cycle is obtained by calculating the equation (2), the motor stops rotating. Therefore, if the voltage level of the analog signal is less than that of the adjustable stop setting voltage signal (2.15V), the stop control signal is outputted to stop the rotation of the motor. On the other hand, if the voltage level of the analog signal is higher than that of the adjustable stop setting signal (2.15V), the analog signal is compared with the triangular signal to output the motor rotation speed ratio and the motor rotation speed ratio will change linearly.

Next, please refer to FIG. 3B, which shows the rotating speed curve in the first embodiment of the present invention.

In FIG. 3B, the horizontal axis shows the duty cycle of the PWM control signal, and the vertical axis shows the motor rotation speed ratio. In ORG status, the variation of the rotating speed curve is observed when the duty cycle is between 0% and 100%. Then, please refer to FIG. 3B and FIG. 3A in conjunction, as shown in FIG. 3B, the result of analog signal are the same as high voltage level and the low voltage level of the triangular signal, and the adjustable stop setting signal is set at 2V. Hence, if the voltage level of the analog signal is less than that of the adjustable stop setting signal, the output of the stop rotation duty cycle is 30%, that is, when the duty cycle of PWM signal is operated among 0% to 30%, the output of the motor rotation speed ratio is maintained at 0%. On the other hand, when the voltage level of the analog signal is higher than that of the adjustable stop setting signal of 2V, the motor rotation duty cycle will change linearly when the duty cycle of PWM signal is higher than 30%.

Thereafter, the variation of the rotating speed curve is observed under CASE1 status, when the duty cycle is varied between 0% and 100%. Then, please refer to FIG. 3B and FIG. 3A in conjunction, as shown in FIG. 3B, when the voltage level of the analog signal begins to vary from 0.625V, the voltage level of the analog signal contacts with that of the triangular signal until the voltage level of the analog signal is changed to 1.25V, so that the motor rotation speed ratio is to be outputted. Hence, if the voltage level of the analog signal is less than that of the adjustable stop setting signal of 1.875V, the output of the stop rotation duty cycle is 40%. That is, if the duty cycle of PWM signal is operated among 0% to 40%, the motor rotation speed ratio is maintained at 0%. On the other hand, if the voltage level of the analog signal is higher than that of the adjustable stop setting signal of 1.875V, the motor rotation duty cycle is linearly varied when the duty cycle PWM signal is higher than 40%.

Furthermore, the variation of the rotating speed curve is observed under CASE 2 status, when the duty cycle is varied between 0% and 100%. Then, please refer to FIG. 3B and FIG. 3A in conjunction, as shown in FIG. 3B, when the voltage level of the analog signal is 1.75V, which is higher than the low voltage level of the triangular signal, the analog signal is contacted with that of the triangular signal, the motor rotation speed ratio is outputted at the beginning. However, the priority of the stop setting signal is higher than that of the PWM signal. Hence, if the voltage level of the analog signal is less than that of the adjustable stop setting signal of 2.15V, the output of the stop rotation ratio is 20%, in other words, if the duty cycle of PWM signal is operated among 0% to 20%, the motor rotation speed ratio is maintained at 0%. On the other hand, when the voltage level of the analog signal is higher than that of the adjustable stop setting signal (2.15V), the motor rotation duty cycle is linearly varied when the duty cycle PWM signal is higher than 20%.

According to the three conditions described above in the first embodiment, the conditions described in the first embodiment can be applied to different rotation demands of motors, and the motor stop duty cycle based on different system demands can be adjusted as well. Also, the purpose of reducing energy loss of the motor, promoting operation efficiency, reducing energy, and reducing carbon emission can be achieved.

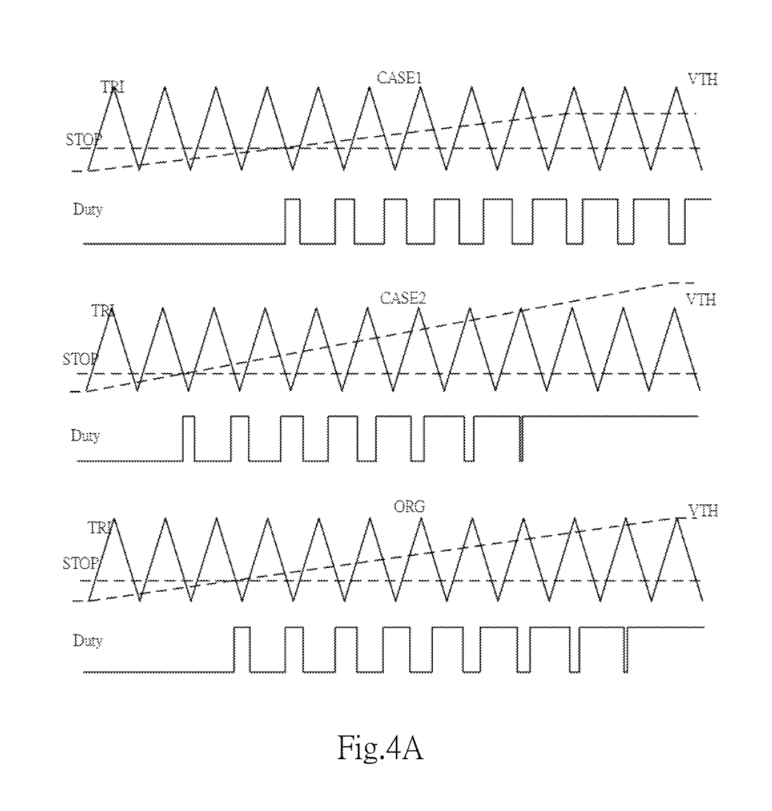

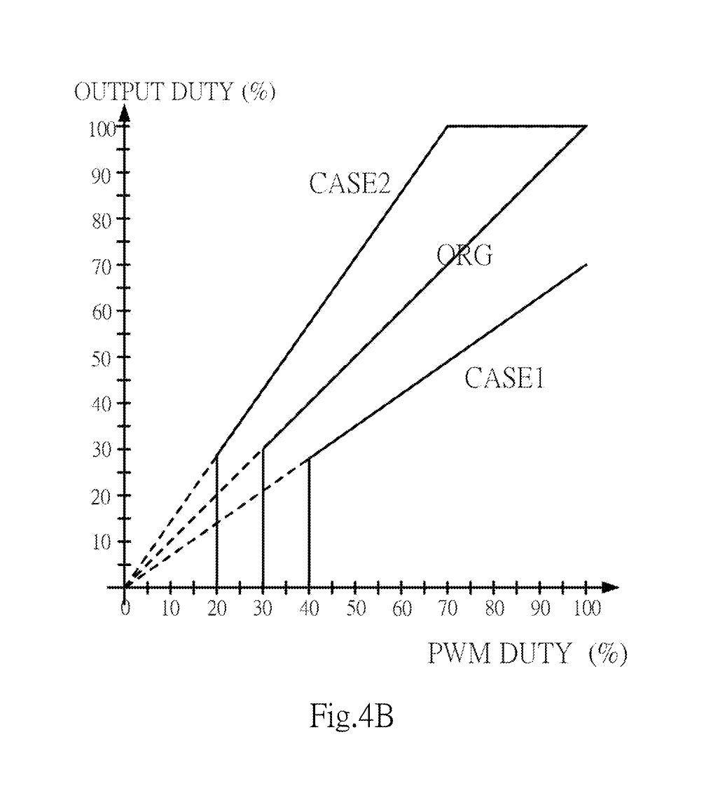

Next, please refer to FIG. 4A, which shows the waveform in the second embodiment of the present invention.

As shown in FIG. 4A, in the second embodiment, the voltage level of the triangular signal is fixed at 3.75V, the low voltage level of the triangular signal is fixed at 1.25V, and the adjustable lowest setting voltage signal is fixed at 1.25V to adjust the adjustable highest setting voltage signal. tinder the aforementioned conditions, three status can illustrate the result of the comparison: ORG(VH=3.75V, and VL=1.25V), CASE1(VH=2.9V, and VL=1.25V), and CASE2(VH=5V, and VL=1.25V) are combined with the adjustable stop setting signal respectively, and the adjustable stop setting signal and the analog signal are inputted into the second comparator 16 to be compared to determine the motor stop duty cycle of the motor 14.

Please still refer to FIG. 4A, when the motor status is at ORG status, the high voltage level of the triangular signal is fixed at 3.75V the low voltage level of the triangular signal is fixed at 1.25V, the adjustable highest setting voltage signal is set at 3.75V, the adjustable lowest setting voltage signal is set at 1.25V, the adjustable stop setting signal is set at 2V, and the analog signal will vary between 1.25V and 3.75V resulted from the equation (1). Furthermore, when the adjustable stop setting signal is set at 2V, the analog signal is compared with the stop setting signal to generate the ORG waveform as shown in FIG. 4A. When the duty cycle of the motor is less than 30% that is calculated by equation (2), the action of the motor can be determined at stop rotation status. Therefore, when the voltage level of the analog signal is less than that of the adjustable stop setting voltage signal (2V), the stop control signal is outputted to stop the rotation of the motor 14 according to the adjustable setting stop signal. On the other hand, when the voltage level of the analog signal is higher than that of the adjustable stop setting signal (2V), the analog signal is compared with the triangular signal to output the motor rotation speed ratio, and the motor rotation speed ratio will change linearly.

Please also refer to FIG. 4A. if the motor status is at CASE 1 status, the high voltage level of the triangular signal is fixed at 3.75V, the low voltage level of the triangular signal is fixed at 1.25V, the adjustable highest setting voltage signal is set at 2.9V, the adjustable lowest setting voltage signal is set at 1.25V, the adjustable stop setting signal is set at 1.91V, and the analog signal will vary between 1.25V and 2.9V resulted from the equation (1). Since the voltage level of the analog signal is 1.25V to contact with the voltage level of the triangular signal, the duty cycle of the motor rotation speed will exist at beginning. However, the highest voltage level of the analog signal is 2.9V, which is less than the high voltage level of the triangular signal, so that the motor rotation speed ratio at CASE 1 status is less than that of the ORG status. Furthermore, when the adjustable stop setting is set at 1.91V, the analog signal is compared with the stop setting signal to generate the waveform of CASE1 as shown in FIG. 4A. When the duty cycle of the motor is less than 40%, the analog signal and stop setting signal are calculated by the equation (2) to obtain the motor action that is at stop status. Therefore, when the voltage level of the analog signal is less than that of the adjustable stop setting voltage signal (1.91V), the stop control signal is outputted to stop the rotation of the motor. On the other hand, when the voltage level of the analog signal is higher than that of the adjustable stop setting signal, (1.91V), the analog signal is compared with the triangular signal to output the motor rotation speed ratio, and the motor rotation speed ratio will change linearly.

Next, please still refer to FIG. 4A. if the motor status is at CASE2 status, the high voltage level of the triangular signal is fixed at 3.75V, the low voltage level of the triangular signal is fixed at 1.25V, the adjustable highest setting voltage signal is set at 5V, the adjustable lowest setting voltage signal is set at 1.25V, the adjustable stop setting signal is set at 2V, and the analog signal will vary between 1.25V and 5V resulted from equation (1). Since the voltage level of the analog signal of 1.25V is contacted with that of the triangular signal, the motor rotation speed ratio is outputted at beginning However, because the highest value of the analog signal is 5V, which is higher than the high voltage 3.75V of the triangular signal (TRI), the motor rotation speed ratio (Duty %) is equal to the motor rotation speed ratio (Duty %) as the analog signal (VTH) is 3.75V in the ORG condition. Furthermore, when the adjustable stop setting signal is set at 2V, the analog signal is compared with the adjustable stop setting signal to generate the waveform of CASE 2 as shown in FIG. 4A. When the duty cycle of the motor is less than 20%, analog signal and stop setting signal are calculated by equation (2) to obtain the motor action that is at stops status. Therefore, when the voltage level of the analog signal is less than that of the adjustable stop setting voltage signal (2V), the stop control signal is outputted to stop the rotation of the motor according to the adjustable stop setting signal. On the other hand, when the voltage level of the analog signal is higher than that of the adjustable stop setting signal (2V), the analog signal is compared with the triangular signal to output the motor rotation speed ratio, and the motor rotation speed ratio will change linearly

Next, please refer to FIG. 4B, which shows the rotating speed curve in the second embodiment of the present invention.

In FIG. 4B, the horizontal axis shows the duty cycle of the PWM control signal, and the vertical axis shows the motor rotation speed ratio. The variation of the rotating speed curve is varied between 0% and 100% in duty cycle that is observed under ORG status. Then, please refer to FIG. 4B and FIG. 4A in conjunction, the result of the analog signal is identical to the high voltage level and the low voltage level of the triangular signal, and the adjustable stop setting signal is set at 2V. Thus, when the voltage level of the analog signal is less than that of the adjustable stop setting signal (2V), the output of the stop rotation duty cycle is 30%, that is, when the duty cycle of PWM signal is operated among 0% to 30%, the output of the motor rotation speed ratio is maintained at 0%. Otherwise, when the voltage level of the analog signal is higher than that of the adjustable stop setting signal (2V), the motor rotation speed ratio is linearly varied when the output of the duty cycle of PWM signal is higher than 30%.

Thereafter, the variation of the rotating speed curve is observed under CASE 1 status, when the duty cycle is varied between 0% and 100%. Then, please refer to FIG. 4B and FIG. 4A in conjunction. As FIG. 4B shows, when the voltage level of the analog signal is at 1.25V to contact with the triangular signal, the motor rotation speed ratio is outputted at beginning. The analog signal is compared with the stop setting signal and the adjustable stop setting signal is set at 1.91V. Thus, when the analog signal is less than the adjustable stop setting signal (1.91V), the output of the duty cycle of PMW signal is 40%, that is, the motor rotation speed ratio is varied between 0% and 40% and the output of the stop rotation duty cycle is maintained at 0%. On the other hand, when the voltage level of the analog signal is higher than that of the adjustable stop setting signal (1.91V), the motor rotation speed ratio will linearly vary when the duty cycle PWM signal is higher than 40%.

Furthermore, the variation of the rotating speed curve is observed under CASE 2 status, when the duty cycle is varied between 0% and 100%. Then, please refer to FIG. 4B and FIG. 4A in conjunction, as shown in FIG. 4B, when the voltage level of the analog signal is 1.25V, which is the same as the low voltage level of the triangular signal, is contacted with that of the triangular signal, the motor rotation speed ratio is outputted at beginning. Besides, the adjustable stop setting signal is compared with the analog signal. Hence, when the voltage level of the analog signal is less than that of the adjustable stop setting signal of 2V, the stop rotation duty cycle of 20% is outputted, that is, when the duty cycle of PWM signal is operated among 0% to 20%, the motor rotation speed ratio is maintained at 0%. On the other hand, when the voltage level of the analog signal is higher than that of the adjustable stop setting signal of 2V, the motor rotation duty cycle is linearly varied when the duty cycle PWM signal is higher than 20%. According to three conditions described above, the second embodiment conditions are suitable for various operation demands of motors, and the stop duty cycle of motor can also be adjusted for reducing power loss and increasing work efficiency of motor, the purpose of saving energy and reducing carbon emission can be achieved as well.

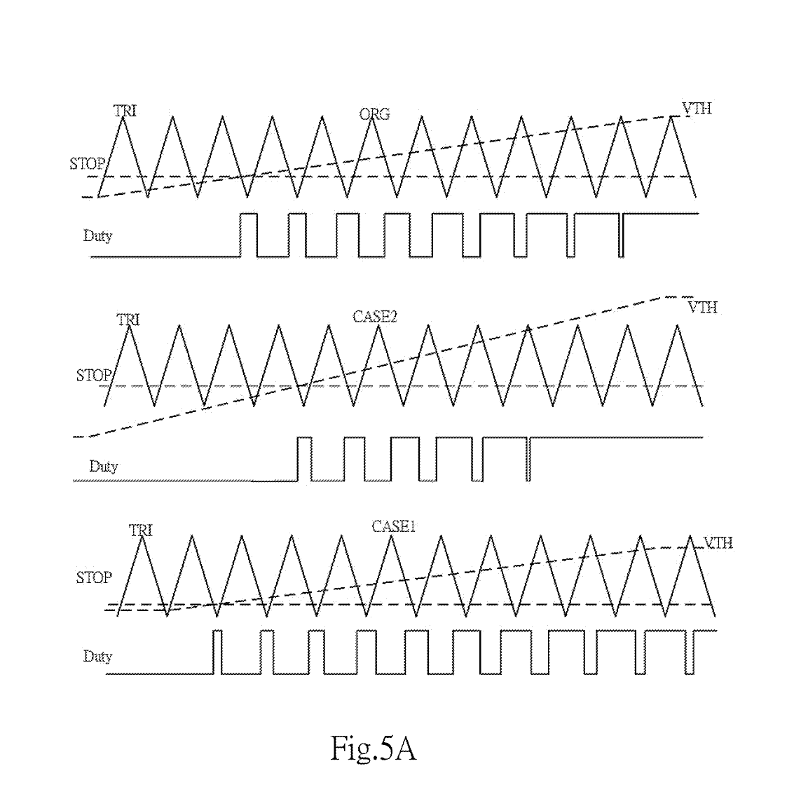

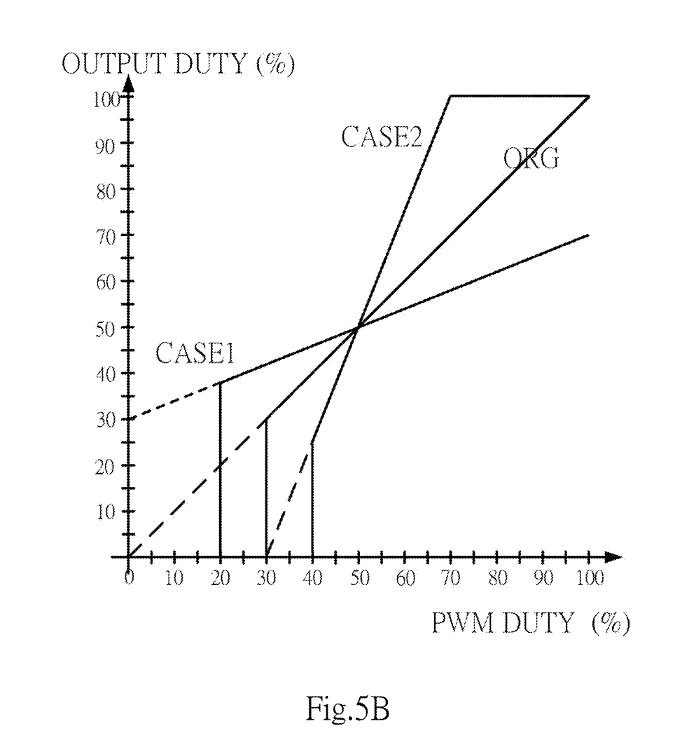

Next, please refer to FIG. 5A, which shows the waveform view in the third embodiment of the present invention.

As the FIG. 5A shows, in the third embodiment of the present invention, the voltage level of the triangular signal is fixed at 3.75V as a constant value, the low voltage level of the triangular signal is fixed at 1.25V, and the adjustable highest setting voltage signal and the adjustable lowest setting voltage signal are adjustable. Under the aforementioned conditions, three status can be illustrate the results of the comparison: ORG(VH=3.75V, and VL=1.25V), CASE1(VH=3V, and VL=2V), and CASE2(VH=5V, and VL=0V) are combined with the adjustable stop setting signal respectively, such that the adjustable stop setting signal and the analog signal are inputted into the second comparator 16 to be compared to determine the motor stop duty cycle of the motor 14.

Please continue to refer to FIG. 5A, when the motor status is at ORG status, the high voltage level of the triangular signal is fixed at 3.75V, the low voltage level of the triangular signal is fixed at 1.25V, the adjustable highest setting voltage signal is set at 3.75V, the adjustable lowest setting voltage signal is set at 1.25V, and the adjustable stop setting signal is set at 2V, and the analog signal will vary between 1.25V and 3.75V resulted from the equation (1). Furthermore, when the adjustable stop setting is set at 2V, the analog signal is compared with the stop setting signal to generate the ORG waveform shown in FIG. 5A. When the duty cycle of the motor is less than 30% calculated by equation (2), the action of the motor can be determined at stop rotation status. Therefore, when the voltage level of the analog signal is less than that of the adjustable stop setting voltage signal (2V), the stop control signal is outputted to stop the rotation of the motor 14. On the other hand, when the voltage level of the analog signal is higher than that of the adjustable stop setting signal (2V), the analog signal is compared with the triangular signal to output the motor rotation speed ratio, and the motor rotation speed ratio is changed linearly.

Please still refer to FIG. 5A. if the motor status is at CASE1 status, the high voltage level of the triangular signal is fixed at 3.75V, the low voltage level of the triangular signal is fixed at 1.25V, the adjustable highest voltage setting signal is set at 3V, the adjustable lowest setting voltage signal is set at 2V, and the adjustable stop setting signal is set at 2.2V and the analog signal would be changed between 2V and 3V resulted from equation (1). Since the voltage level of the analog signal is 2V to contact with the voltage level of the triangular signal, the duty cycle of the motor rotation speed is outputted at beginning The duty cycle of the motor rotation speed at CASE1 condition is higher than that of the ORG condition when the voltage level of the analog signal is 1.25V. On the other hand, when the voltage level of the analog signal is 3V, which is less than the high voltage level of the triangular signal (3.75V), the duty cycle of the motor rotation speed of CASE1 condition is less than that of ORG condition with the voltage level of the analog signal (3.75V). Besides, the adjustable stop setting signal is compared with the analog signal to obtain the CASE1 waveform shown in FIG. 5A, and the motor stops when the duty cycle of motor is less than 20% resulted from equation (2). Hence, when the adjustable stop setting is set at 2.2V, the analog signal is compared with the stop setting signal to generate the CASE1 waveform shown in the FIG. 5A. When the duty cycle of the motor is less than 20% calculated by the equation (2), the motor stops rotating. Therefore, if the voltage level of the analog signal is less than that of the adjustable stop setting voltage signal (2.2V), the stop control signal is outputted to stop the rotation of the motor. On the other hand, if the voltage level of the analog signal is higher than that of the adjustable stop setting signal (2.2V), the analog signal is compared with the triangular signal to output the motor rotation speed ratio, and the motor rotation speed ratio will change linearly.

Thereafter, please still refer to FIG. 5A. if the motor status is at CASE2, the high voltage level of the triangular signal is fixed at 3.75V the low voltage level of the triangular signal is fixed at 1.25V, the adjustable highest setting voltage signal is set at 5V, the adjustable lowest setting voltage signal is set at 0V, the adjustable stop setting signal is set at 2V, and the analog signal would vary between 0V and 5V which is obtained by calculating the equation (1). Since the voltage level of analog signal is changed from 0V, the voltage level of the analog signal is changed to be 1.25V to contact with the voltage level of the triangular signal, and the duty cycle of the motor rotation speed is outputted when the voltage level of the analog signal is 1.25V. However, because the highest voltage level of the analog signal is 5V, which is higher than that of high voltage level of the triangular signal (3.75V), the duty cycle of the motor rotation speed of CASE2 condition is equal to that of the ORG condition when the voltage level of the analog signal is 3.75V. Furthermore, the analog signal is compared with the stop setting signal to generate the waveform of CASE2 shown in the FIG. 5A. When the duty cycle of the motor is less than 40% obtained by calculating the equation (2), the motor stops rotating. Therefore, if the voltage level of the analog signal is less than that of the adjustable stop setting voltage signal (2V), the stop control signal is outputted to stop the rotation of the motor. On the other hand, when the voltage level of the analog signal is higher than that of the adjustable stop setting signal (2V), the analog signal is compared with the triangular signal to output the motor rotation speed ratio, and the motor rotation speed ratio will change linearly.

Next, please refer to FIG. 5B, which shows the rotating speed curve in the third embodiment of the present invention.

In FIG. 5B, the horizontal axis shows the duty cycle of the PWM control signal, and the vertical axis shows the motor rotation speed ratio. In ORG condition, the variation of the rotating speed curve is observed when the duty cycle is between 0% and 100%. Then, please refer to FIG. 5B and FIG. 5A in conjunction, as shown in FIG. 5B, the result of analog signal are the same as high voltage level and the low voltage level of the triangular signal, and the adjustable stop setting signal is set at 2V Hence, if the voltage level of the analog signal is less than that of the adjustable stop setting signal, the output of the stop rotation duty cycle is 30%, that is, when the duty cycle of PWM signal is operated among 0% to 30%, the output of the motor rotation speed ratio is maintained at 0%. On the other hand, when the voltage level of the analog signal is higher than that of the adjustable stop setting signal (2V), the motor rotation ratio will linearly vary when the duty cycle PWM signal is higher than 30%.

Thereafter, In CASE1 condition, it is to observe the variation of the rotating speed curve when the duty cycle is varied between 0% and 100%. Then, please refer to FIG. 5B and FIG. 5A in conjunction, as FIG. 5B shows, since the low voltage level of the analog signal is 2V to contact with the triangular signal, the motor rotation speed ratio is outputted at beginning. The duty cycle of the motor rotation of CASE1 condition is higher than that of ORG condition with the voltage level of analog signal of 1.25V. On the other hand, since the voltage level of the analog signal is 3V, which is less than that of the highest voltage level of triangular signal (3.75V), the motor rotation speed ratio of CASE1 condition is less than that of the ORG condition. Hence, if the voltage level of the analog signal is less than that of the adjustable stop setting signal of 2.2V, the output of the stop rotation ratio is 20%, that is, if the duty cycle of PWM signal is operated among 0% to 20%, the motor rotation speed ratio is maintained at 0%. On the other hand, if the voltage level of the analog signal is higher than that of the adjustable stop setting signal (2.2V), the motor rotation ratio is linearly varied when the duty cycle PWM signal is higher than 20%.

Furthermore, In CASE2 condition, it is to observe the variation of the rotating speed curve when the duty cycle is between 0% and 100%. Then, please refer to FIG. 5B in conjunction with FIG. 5A, as FIG. 5B shows, since the voltage level of the analog signal is changed from 0V, the voltage level of the analog signal is changed to 1.25V to contact with that of the triangular signal, and the duty cycle of the motor rotation is outputted. Since the highest voltage level of the analog signal is 5V, which is higher than that of triangular signal (3.75V), the motor rotation speed ratio of CASE2 condition is higher than that of ORG condition. Hence, if the voltage level of the analog signal is less than that of the adjustable stop setting signal (2V), the output of the stop rotation duty cycle is 40%, that is, if the duty cycle of PWM signal is operated among 0% to 40%, the motor rotation speed ratio is maintained at 0%. On the other hand, if the voltage level of the analog signal is higher than that of the adjustable stop setting signal (2V), the motor rotation ratio is linearly varied when the duty cycle PWM signal is higher than 40%.

According to the three conditions described above in the three embodiments, adjusting different voltage levels of the highest setting voltage signal and the lowest setting voltage signal can meet different system demands. Furthermore, the motor stop duty cycle can be also adjusted for different system demands due to the stop setting of motor of the present invention, and thus significantly increasing applicability, reducing energy loss, and promoting operation efficiency of motor, and the purpose of saving energy and reducing carbon emission can be achieved as well.

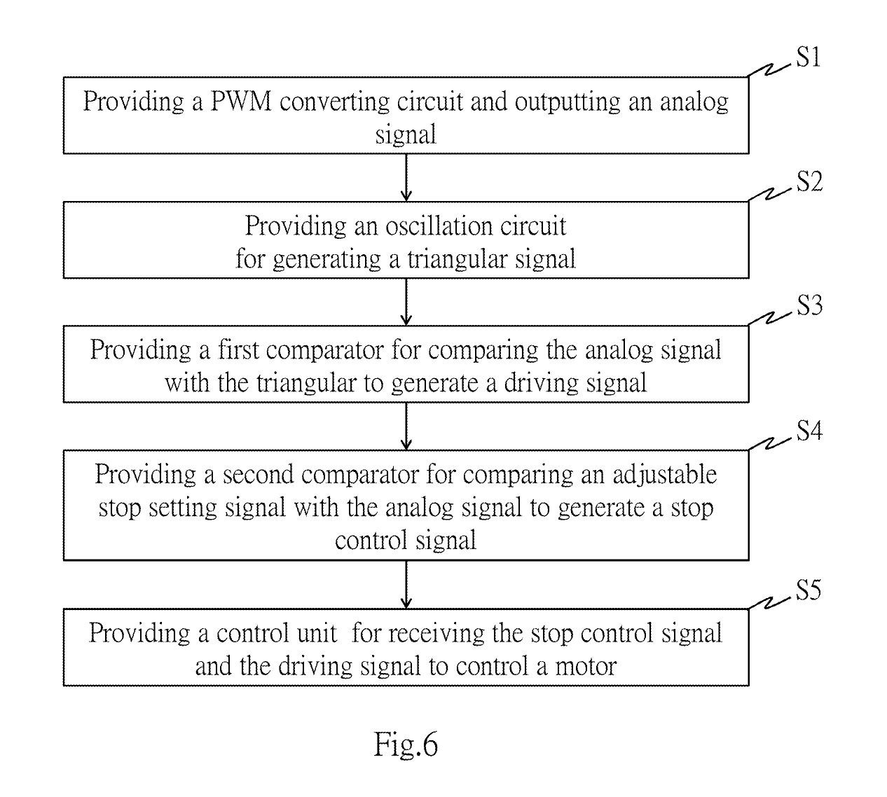

Finally, please refer to FIG. 6, which shows a flowchart illustrating the motor driving method in the present invention. The flowchart includes the following steps:

In step S1, providing the PWM converting circuit, including the first input terminal, the second input terminal, the third input terminal, and the output terminal. The first input terminal receives the PWM signal, and the second input terminal receives the adjustable highest setting voltage signal, and the third input terminal receives the adjustable lowest setting voltage signal, and the output terminal outputs the analog signal. The analog signal can be changed by adjusting the voltage level of the PWM signal, adjustable highest setting voltage, or the adjustable lowest setting voltage.

Next, in the step S2, providing the oscillation circuit for generating the triangular signal, and the voltage level of the triangular signal can be adjusted between the high voltage level and the low voltage level.

Next, in the step S3, providing the first comparator for comparing the voltage level of the analog signal with that of the triangular signal to generate the driving signal.

Next, in the step S4, providing the second comparator for comparing the voltage level of the adjustable stop setting signal with that of the analog signal to generate the stop control signal.

Finally, in the step S5, providing the control unit, which receives the driving signal outputted from the first comparator and the stop setting signal outputted from the second comparator to determine the motor stop rotation ratio so as to control the motor.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A motor driving device with rotation and stop setting mode comprises a PWM converting circuit, an oscillation circuit, a first comparator, a second comparator, and a control unit, the PWM converting circuit receives an adjustable highest setting voltage signal, an adjustable lowest setting voltage signal, and a control signal and outputs an analog signal to the first comparator, and the oscillation circuit generates a triangular signal to the first comparator, and the first comparator receives the analog signal and the triangular signal and outputs a driving signal to the control unit, and the characteristic in that:
the second comparator includes a first input terminal, a second input terminal, and an output terminal, and the first input terminal receives an adjustable stop setting signal, and the second input terminal receives the analog signal, the second comparator compares the adjustable stop setting signal and the analog signal to output a stop setting signal to the control unit from the output terminal, and the control unit receives the driving signal and the stop setting signal to determine a motor stop duty cycle.

2. The motor driving device with rotation and stop setting mode of claim 1, wherein the adjustable stop setting signal is a voltage signal.

3. The motor driving device with rotation and stop setting mode of claim 1, wherein the analog signal is changed by adjusting the control signal, the adjustable highest setting voltage signal, or the adjustable lowest setting voltage signal.

4. The motor driving device with rotation and stop setting mode of claim 1, wherein the control signal is PWM signal.

5. The motor driving device with rotation and stop setting mode of claim 1, wherein the motor is a single phase motor.

6. The motor driving device with rotation and stop setting mode of claim 1, the motor is a three phase motor.

7. A motor driving method for setting a motor stop duty cycle, comprising:
receiving an adjustable highest setting voltage signal, an adjustable lowest setting voltage signal, and a control signal to generate an analog signal;
providing a triangular signal;
comparing the analog signal with the triangular signal to generate a driving signal;
comparing the analog signal with an adjustable stop setting signal to output a rotation and stop setting control signal; and
receiving the driving signal and the rotation and stop setting control signal to determine a motor stop duty cycle.

8. The motor driving method of claim 7, wherein the adjustable stop setting signal is a voltage signal.

9. The motor driving method of claim 7, wherein the voltage level of the analog signal is changed by adjusting the voltage level of the control signal, the adjustable highest setting voltage signal, or the adjustable lowest setting voltage signal.

10. The motor driving method of claim 7, wherein the control signal is PWM signal.
